(19) United States
(12) Patent Application Publication
(10) Pub. No.: US 2005/0077655 A1
(43) Pub. Date: Apr. 14, 2005

(54) Method of preventing adhesion of gypsum foreign matter of gypsum slurry, gypsum slurry supply stabilizing device with gypsum foreign matter adhesion prevention device, and method of manufacturing gypsum board by using the stabilizing device

(75) Inventors: Minoru Ikeda, Nei-gun (JP); Makoto Tsugeno, Nei-gun (JP); Junichi Yoshikawa, Nei-gun (JP)

Correspondence Address: OLIFF & BERRIDGE, PLC, P.O. BOX 19928, ALEXANDRIA, VA, 22320, US

(73) Assignee: Nissan Kenzai CO., LTD., Nei-gun (JP)

(21) Appl. No.: 10/504,573

(22) PCT Filed: Feb. 14, 2003
(86) PCT No.: PCT/JP03/01541

(30) Foreign Application Priority Data
Feb. 18, 2002 (JP) 2002-39952

(51) Int. Cl. B06B 1/02; B28B 1/00

(52) U.S. Cl. 264/442; 264/112; 425/456

(57) ABSTRACT

The method of preventing adhesion of gypsum foreign matter comprises providing ultrasonic vibration to a member coming into contact with a gypsum slurry containing air bubbles.

### TECHNICAL FIELD

The present invention relates to manufacture of construction materials in which gypsum slurry containing air bubbles is handled, particularly manufacture of gypsum boards that are popular as interior materials.

Gypsum slurry in the present invention means an aqueous slurry containing as main components calcined gypsum (gypsum hemihydrate) and/or gypsum dihydrate being raw material.

### BACKGROUND ART

Gypsum boards are widely used as architectural interior materials having fire properties, fire resistance and sound insulation.

The gypsum board is a sheet-like product in which a core material containing gypsum as a main component is covered with base paper for gypsum board. The method of manufacture thereof comprises kneading calcined gypsum, water and several additives with a mixer to obtain gypsum slurry containing air bubbles, flowing the gypsum slurry between upper and lower papers, passing it through a forming roll or a plate to form a sheet having a prescribed thickness, hardening gradually it on a conveyor belt, cutting preliminarily it with a cutter, then subjecting it to a board drying process and cutting finally it in a prescribed size to obtain a product.

The gypsum slurry is generally kneaded with a thin circular mixer. The gypsum slurry prepared by using the mixer is obtained by kneading calcined gypsum, water and several additives. This process is expressed by the following equation (1):
CaSO₄.1/2 H₂O+3/2 H₂O→CaSO₄.2H₂O (1)
Calcined gypsum (gypsum hemihydrate) gypsum dihydrate
gypsum is exothermically hardened in a process in which calcined gypsum (gypsum hemihydrate) being raw material is hydrated to form gypsum dihydrate. In the process, a hardened material as a gypsum foreign matter (scale) adheres or grows in a member at which the interior of the mixer or each member of a gypsum slurry supply stabilizing device comes into contact with the gypsum slurry. When the hardened material drops (gypsum foreign matter dropping), the base paper is cut at the forming roll, which results in a stop of the production line.

JP-A-2000-262882 discloses a pin-type mixing agitator having a specific shape that is hard to adhere a solidified matter of slurry.

In addition, JP-A-2000-006137 proposes a mixing agitator used in manufacture of gypsum board, in which an attachment (grid-like or slit-like) having an opening for selective passing is provided on a slurry discharge port.

These devices are effective for prevention of gypsum foreign matter formed in the mixing agitator, but they require other means for prevention of gypsum foreign matter adhered or grown in the gypsum slurry supply devices.

In the conventional manufacture of gypsum boards, it is an actual situation that gypsum slurry supply pipes (shoot) made of flexible plastics or rubber are used as gypsum slurry supply devices, and an operator crumbles gypsum foreign matters adhered or grown in the gypsum slurry supply devices until they are soft.

In addition, as a technique utilizing ultrasonic wave, JP-A-54-061070 (1979) proposes a method for preventing scale formation in wet desulfurization of exhaust combustion gas using lime and gypsum, characterized by irradiating with ultrasonic wave at least a part of a washing and absorbing solution which is used repeatedly in each step and which contains supersaturated calcium sulfate, and thereby depositing compulsorily calcium sulfate.

For the washing and absorbing solution containing no air bubble, it is effective to irradiate the solution with ultrasonic wave. However, gypsum slurry containing air bubbles adversely affects propagation of ultrasonic wave, and therefore the above-mentioned compulsory deposit effect can not be expected.

When gypsum foreign matters are left adhering or growing in a gypsum slurry supply devices, they lead to clogging of gypsum slurry supply pipes. The presence of hardened gypsum foreign matter larger than a prescribed thickness (a production thickness) in forming rolls or plates results in a stop of the production line due to cut of base paper. Therefore, the use of a large labor force requires for eliminating or washing the hardened gypsum foreign matter or for cleaning or restoring conveyor belt or production machine, and results in a lowering of productivity and an increase in cost.

Even when contaminates in a product are gypsum foreign matters less than the product thickness, they have adverse effects on the characteristics of product. Therefore, in the conventional manufacture of gypsum boards, it is an actual situation that gypsum slurry supply pipes made of flexible plastics or rubber are used as gypsum slurry supply devices, and an operator crumbles gypsum foreign matters adhered or grown in the gypsum slurry supply device until they are soft.

It is an object of the present invention to provide a method of preventing adhesion of gypsum foreign matter of gypsum slurry containing air bubbles, gypsum slurry supply stabilizing device with a gypsum foreign matter adhesion prevention device, and a method of manufacturing gypsum boards by using the stabilizing device.

### DISCLOSURE OF INVENTION

A first aspect of the present invention is a method of preventing adhesion of gypsum foreign matter comprising providing ultrasonic vibration to a member coming into contact with a gypsum slurry containing air bubbles.

In the meanwhile, it is appropriate to carry out the first aspect according to the following embodiments:
the ultrasonic vibration is an ultrasonic wave having a frequency of 10 to 100 kHz;
the material of the member is metal;
the member is a gypsum slurry supply device;
the member is a gypsum slurry flow control device;
the member is a gypsum foreign matter stop device; and
the member is an edge folding device.

A second aspect of the present invention is a gypsum slurry supply stabilizing device in which ultrasonic vibration is provided to a member coming into contact with a gypsum slurry containing air bubbles.

In the meanwhile, it is appropriate to carry out the second aspect according to the following embodiments:
the ultrasonic vibration is an ultrasonic wave having a frequency of 10 to 100 kHz;
the material of the member is metal;
the member is a gypsum slurry supply device;
the member is a gypsum slurry flow control device;
the member is a gypsum foreign matter stop device; and
the member is an edge folding device.

A third aspect of the present invention is a method of manufacturing a gypsum board characterized by using the gypsum slurry supply stabilizing device according to the second aspect.

### BRIEF DESCRIPTION OF DRAWINGS

FIG. 1 is a schematic view showing a process of manufacture of gypsum boards in case where one mixer is used;

FIG. 2 is a schematic view showing a process of manufacture of gypsum boards in case where two mixers, a main mixer and a sub-mixer are used;

FIG. 3 a schematic view showing a mixer and a gypsum slurry supply device (one gypsum slurry supply pipe); and

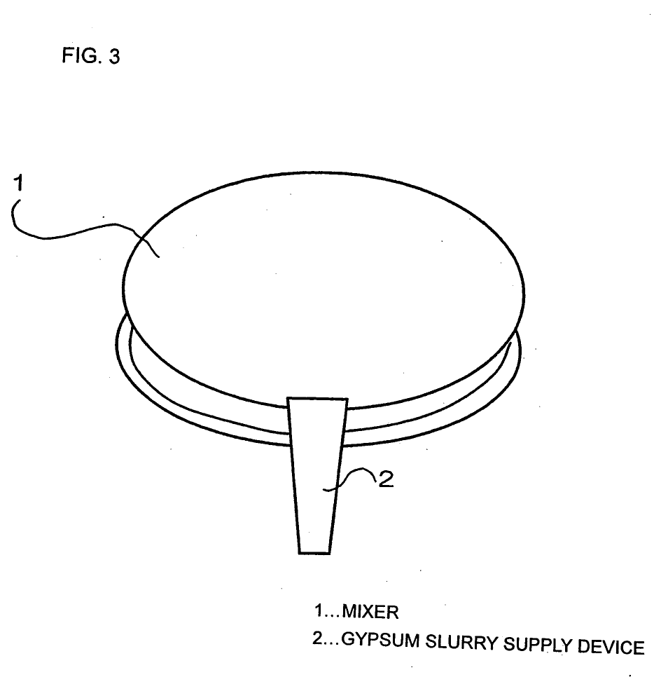

FIG. 4 is a schematic view showing a mixer and a gypsum slurry supply device (three gypsum slurry supply pipes).

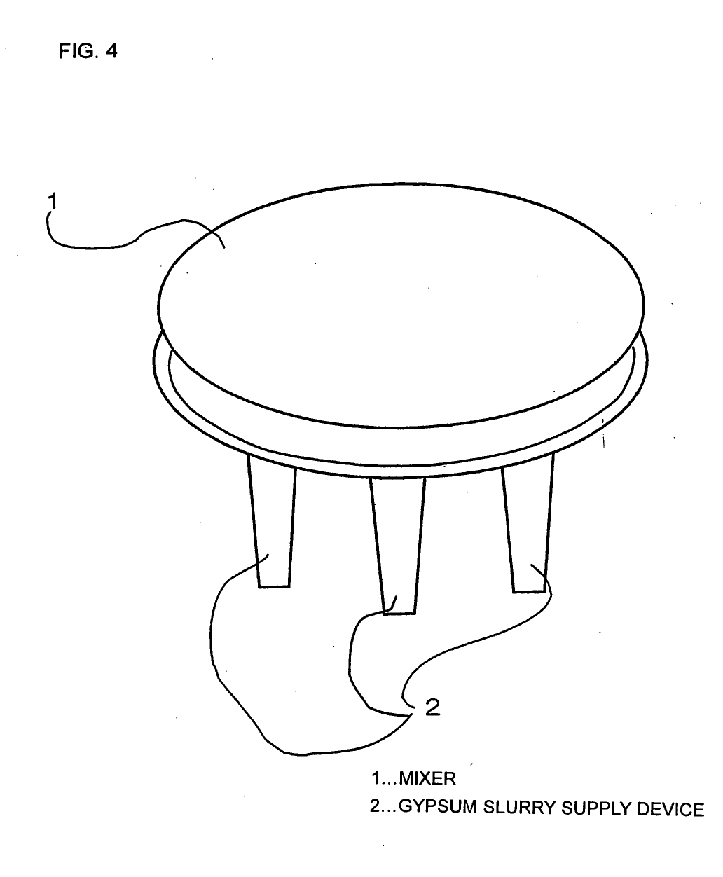

### BEST MODE FOR CARRYING OUT THE INVENTION

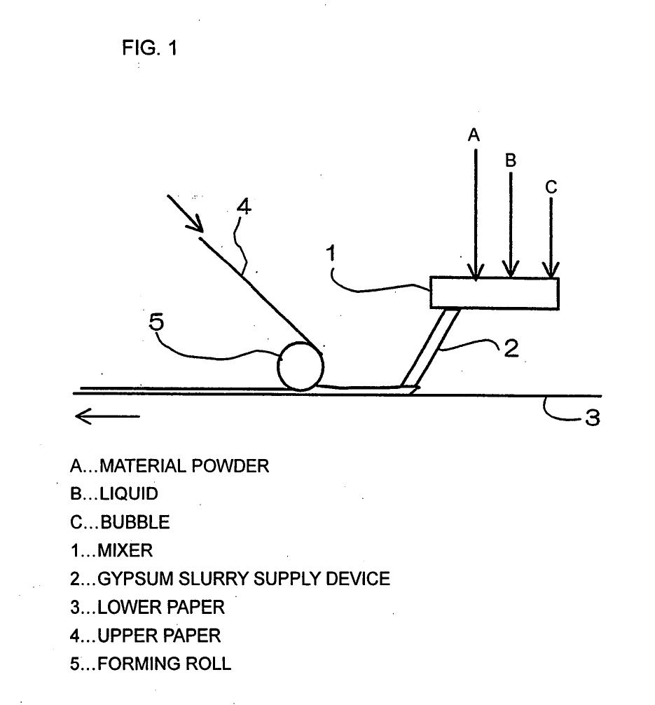

Hereinafter, embodiments of the present invention are concretely described with the aid of drawings. In the present invention, as shown in FIG. 1, material powders such as calcined gypsum, an auxiliary adhesive, a hardening accelerator and the like, bubbles and liquid including a water reducing agent and the like were fed into a mixer 1 and kneaded. Next, a gypsum slurry containing air bubbles kneaded in the mixer 1 was supplied from a mixer opening (outlet port) to a production line through a gypsum slurry supply device (gypsum slurry supply pipe) 2 provided with ultrasonic vibration, and spread on a lower paper 3, and then covered with an upper paper 4. Further, the resulting product was passed through a forming roll 5 to make the surface thereof flat.

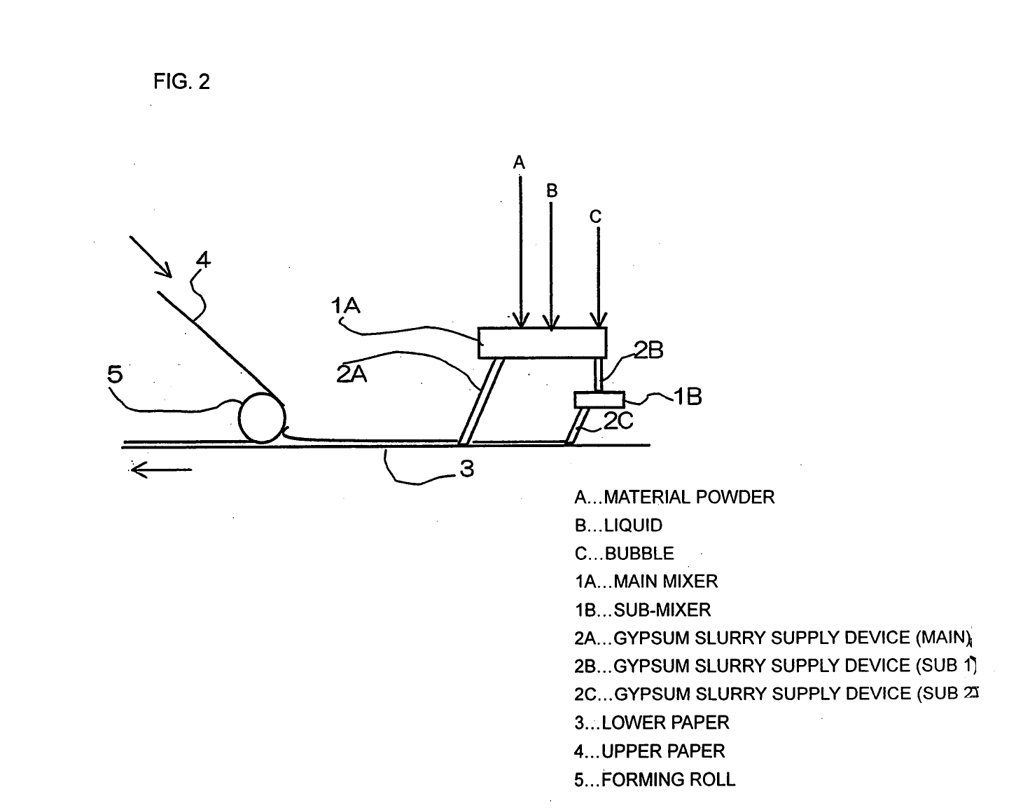

In addition, as shown in FIG. 2, a combination of a plurality of mixers with a plurality of gypsum slurry supply devices may be used. That is, the following embodiments may be adopted: one embodiment in which material powders, bubbles and liquid were kneaded in a main mixer 1, thereafter kneaded in a sub-mixer 1B again through a gypsum slurry supply device (sub 1) 2B, and then supplied to a production line through a gypsum slurry supply device (sub 2) 2C; and another embodiment in which a gypsum slurry was directly supplied to a production line from a main mixer 1A through a gypsum slurry supply device (main) 2A besides from a sub-mixer 1B.

Hereinafter, gypsum slurry stabilizing devices provided with measures for preventing adhesion of gypsum foreign matter are described.

A gypsum slurry supply device 2 is described.

The function of the device is to supply stably (to prevent scattering of) a gypsum slurry from a mixer opening (outlet port, side face or bottom of the mixer) to a lower paper 3 on a conveyor belt, and to afford the spread of the slurry in the width direction of base paper. In addition, it is necessary to prevent process troubles such as clogging accompanied by adhesion or growth of gypsum foreign matter.

The device structure generally comprises 1 to about 5 gypsum supply pipes. In case where there are a plurality of mixers, as disclosed in JP-A-2001-300933, the gypsum supply pipes may be equipped on both openings (outlet ports) of the main mixer and sub-mixer.

The shape of the gypsum slurry supply device 2 is generally pipe-like, and the cross-section surface thereof contains preferably a shape having a plane part for attaching an ultrasonic oscillator. In addition, the device preferably has neither acute part nor uneven part in such a manner that flow of the slurry is not disrupted. However, the shape of the device is not specifically limited.

The material of the gypsum slurry supply pipe is preferably metal material having little attenuation of ultrasonic vibration. Rigid plastics, ceramics, glass or the like that can propagate ultrasonic vibration can be used.

Next, the method for providing ultrasonic vibration is described.

It is general to attach an ultrasonic oscillator for providing ultrasonic vibration. The ultrasonic oscillator may be attached directly to an arbitrary point on the members of gypsum slurry supply device 2. For example, it can be attached not on the gypsum slurry supply pipe itself but on an outer substrate for propagating ultrasonic vibration to the above-mentioned member through a vibration medium.

The connection of the oscillator with the member can be carried out with an adhesive such as an epoxy resin or the like, welding or bolting, etc. to which the present invention is not limited.

The ultrasonic oscillator (piezoelectric material) for generating ultrasonic vibration includes piezoelectric ceramics, piezoelectric polymer membranes, piezoelectric thin films and the like.

The piezoelectric ceramics in which ceramics being a vibrator are inserted between electrodes generate ultrasonic wave by applying a voltage thereto to repeat stretching of the vibrator and make it vibrate. The ceramics include barium titanate, lead zirconate titanate (PZT), lead titanate and the like.

The piezoelectric polymer membranes are produced by applying polarization to a membrane manufactured from a melt or solution of a polymer such as polyvinylidene fluoride.

The piezoelectric thin films are produced according to a sputtering process by the use of a material such as zinc oxide.

Frequency ranging from 10 kHz to 10 MHz can be utilized. Oscillators generating frequency of 10 to 100 kHz are preferable as they are commercially available and therefore are easy to utilize.

The gypsum slurry flow control device is described.

In order to control the direction, width and thickness of the gypsum slurry flow on the lower paper 3, when a metal plate or the like is entered in gypsum slurry flowing together with the lower paper 3, gypsum foreign matters are adhered or grown on the face of the metal plate with which the gypsum slurry is contacted. Therefore, such a metal sheet could not be practically used.

The gypsum slurry control device in which the ultrasonic vibration is provided, such as a flow control plate according to the present invention prevents adhesion or growth of gypsum foreign matter on the face of the plate with which the gypsum slurry is contacted, even when the plate is entered into the flowing gypsum slurry. Therefore, it is able to control the direction, width and thickness of the gypsum slurry flow.

In the meanwhile, the method for providing ultrasonic vibration is the same as that of the gypsum slurry supply device 2.

The gypsum foreign matter stop device is described.

The gypsum foreign matter stop device in which ultrasonic vibration is provided, such as a comb-shaped foreign matter stop plate (a comb-shaped plate) according to the present invention is provided in front of a forming roll 5 or plate and is entered into the gypsum slurry, thereby collecting gypsum foreign matters formed in the mixer 1 or the gypsum slurry supply device 2.

In the meanwhile, the method for providing ultrasonic vibration is the same as that of the gypsum slurry supply device 2.

The edge folding device is described.

The edge folding device in which ultrasonic vibration is provided according to the present invention is provided on a part in which the lower paper is folded for folding the edges of both sides of the lower paper 3 on which gypsum slurry is laid in front of the forming roll 5 or a plate. Thereby, it prevents the adhesion or growth of gypsum foreign matters and exerts a good edge folding action.

In the meanwhile, the method for providing ultrasonic vibration is the same as that of the gypsum slurry supply device 2.

### EXAMPLE 1

A gypsum slurry supply pipe (made of stainless steel) equipped with 3 bolt-clamped Langevin type PZT oscillators (frequency 28 kHz, total output 190 W) was attached to a port opening of a mixer.

A gypsum slurry containing air bubbles prepared by kneading material powders, liquid and bubbles was poured from a mixer through the gypsum slurry supply pipe (made of stainless steel) provided with ultrasonic vibration onto a lower paper, then an upper paper was withdrawn and the gypsum slurry was covered with the upper paper and lower paper with a forming roll. As mentioned above, a continuous production of gypsum boards was carried out.

Consequently, no adhesion or growth of gypsum foreign matter on the gypsum slurry supply pipe was recognized, and it was able to continuously operate for 24 hours.

### COMPARATIVE EXAMPLE 1

A gypsum slurry supply pipe made of flexible vinyl chloride was attached to a port opening of a mixer.

A gypsum slurry containing air bubbles prepared by kneading a calcined gypsum, water, a blowing agent and several additives was poured from a mixer through the gypsum slurry supply pipe (made of flexible vinyl chloride) onto a lower paper, then an upper paper was withdrawn and the gypsum slurry was covered with the upper paper and lower paper with a forming roll. As mentioned above, a continuous production of gypsum boards was carried out.

In the process, gypsum foreign matters were adhered or grown on the gypsum slurry supply pipe. Therefore, it was necessary to carry out a continuous operation while gypsum foreign matters adhered or grown in the inside of the flexible vinyl chloride pipe were crumbled until they were soft every a prescribed time (every some minutes).

### COMPARATIVE EXAMPLE 2

A gypsum slurry containing air bubbles prepared by kneading material powders, liquid and bubbles was poured from a mixer through the gypsum slurry supply pipe (made of stainless steel) provided with ultrasonic vibration onto a lower paper similarly to Example 1, then a control plate (height 100 mm, width 300 mm, thickness 1 mm, made of stainless steel) was entered into the gypsum slurry on the lower paper to control the direction and width of the gypsum slurry flow, and an upper paper was withdrawn and the gypsum slurry was covered with the upper paper and lower paper with a forming roll. As mentioned above, a continuous production of gypsum boards was carried out.

Some minutes after an operation was carried out, adhesion or growth of gypsum foreign matters occurred in the control plate (made of stainless metal), and was not able to attain an object.

### EXAMPLE 2

A control plate (made of stainless steel) of the present invention was prepared by providing one bolt-clamped Langevin type PZT oscillator (frequency 28 kHz, total output 70 W) on the upper end of a control plate (height 100 mm, width 300 mm, thickness 1 mm, made of stainless steel).

Similarly to Example 1, a gypsum slurry containing air bubbles prepared by kneading material powders, liquid and bubbles was poured from a mixer through the gypsum slurry supply pipe (made of stainless steel) provided with ultrasonic vibration onto a lower paper, the control plate (height 100 mm, width 300 mm, thickness 1 mm, made of stainless steel) of the present invention was entered into the gypsum slurry on the lower paper to control the direction and width of the gypsum slurry flow, and an upper paper was withdrawn and the gypsum slurry was covered with the upper paper and lower paper with a forming roll. As mentioned above, a continuous production of gypsum boards was carried out.

Consequently, no adhesion or growth of gypsum foreign matter on the control plate (made of stainless steel) was recognized, and it was able to continuously operate for 24 hours.

### EXAMPLE 3

A comb-shaped foreign matter stop plate of the present invention was prepared by providing two bolt-clamped Langevin type PZT oscillators (frequency 28 kHz, total output 120 W) on the upper end of a comb-shaped foreign matter stop plate (height 100 mm, width 900 mm, thickness 1 mm, height of comb teeth 50 mm, slit width 5 mm intervals, made of stainless steel).

Similarly to Comparative Example 1, a gypsum slurry containing air bubbles prepared by kneading material powders, liquid and bubbles was poured from a mixer through the gypsum slurry supply pipe made of flexible vinyl chloride onto a lower paper, then the comb-shaped foreign matter stop plate of the present invention was entered into the gypsum slurry on the lower paper. In this case, although the gypsum slurry was contaminated by foreign matters formed in the gypsum slurry supply pipe made of flexible vinyl chloride, the foreign matters were captured by the comb-shaped foreign matter stop plate of the present invention. Therefore, process troubles such as cut of lower paper did not occur. Thereafter, an upper paper was withdrawn and the gypsum slurry was covered with the upper paper and lower paper with a forming roll. As mentioned above, a continuous production of gypsum boards was carried out.

In addition, no adhesion or growth of gypsum foreign matter on the comb-shaped foreign matter stop plate (made of stainless steel) was recognized, and it was able to continuously operate for 24 hours.

### EXAMPLE 4

An edge folding device (guide) of the present invention was prepared by providing 2 bolt-clamped Langevin type PZT oscillators (frequency 28 kHz, total output 130 W) on the upper end of an edge folding device (guide) (height 100 mm, width 400 mm, thickness 6 mm, made of stainless steel) for forming edges of gypsum board.

Similarly to Example 1, a gypsum slurry containing air bubbles prepared by kneading material powders, liquid and bubbles was poured from a mixer through the gypsum slurry supply pipe (made of stainless steel) provided with ultrasonic vibration onto a lower paper, the lower paper on which the gypsum slurry was laid was passed through the edge folding device (guide) of the present invention for folding both edges of the lower paper, then an upper paper was withdrawn and the gypsum slurry was covered with the upper paper and lower paper with a forming roll. As mentioned above, a continuous production of gypsum boards was carried out.

Consequently, no adhesion or growth of gypsum foreign matter was recognized on the guide face (made of stainless steel) with which the gypsum slurry was contacted.

### EXAMPLE 5

The procedures in Example 1 were repeated except that five bolt-clamped Langevin type PZT oscillators (frequency 33 kHz, total output 120 W) were used as oscillator. As a result of it, no adhesion or growth of gypsum foreign matter was recognized, similarly to Example 1.

### EXAMPLE 6

The procedures in Example 1 were repeated except that five bolt-clamped Langevin type PZT oscillators (frequency 19 kHz, total output 100 W) were used as oscillator. As a result of it, no adhesion or growth of gypsum foreign matter was recognized, similarly to Example 1.

### EXAMPLE 7

The procedures in Example 2 were repeated except that one bolt-clamped Langevin type PZT oscillator (frequency 45 kHz, total output 60 W) was used as oscillator. As a result of it, no adhesion or growth of gypsum foreign matter was recognized, similarly to Example 2.

Industrial Applicability

The present invention provides a method of preventing adhesion of gypsum foreign matter of gypsum slurry containing air bubbles, gypsum slurry supply stabilizing device with a gypsum foreign matter adhesion prevention device, and a method of manufacturing gypsum boards by using the stabilizing device, based on a technical idea that ultrasonic vibration is provided to a member coming into contact with gypsum slurry containing air bubbles and thereby preventing adhesion of gypsum foreign matter. According to the present invention, labor force is lowered, troubles such as cut of base paper accompanied with gypsum foreign matter dropping are prevented, and productivity of gypsum boards is improved.

In addition, the present invention can prevent contamination of gypsum foreign matter into gypsum boards, and thereby providing gypsum board having good quality characteristics.

1. A method of preventing adhesion of gypsum foreign matter comprising providing ultrasonic vibration to a member coming into contact with a gypsum slurry containing air bubbles.

2. The method of preventing adhesion of gypsum foreign matter according to claim 1, wherein the ultrasonic vibration is an ultrasonic wave having a frequency of 10 to 100 kHz.

3. The method of preventing adhesion of gypsum foreign matter according to claim 1, wherein the material of the member is metal.

4. The method of preventing adhesion of gypsum foreign matter according to claim 1, wherein the member is a gypsum slurry supply device.

5. The method of preventing adhesion of gypsum foreign matter according to claim 1, wherein the member is a gypsum slurry flow control device.

6. The method of preventing adhesion of gypsum foreign matter according to claim 1, wherein the member is a gypsum foreign matter stop device.

7. The method of preventing adhesion of gypsum foreign matter according to claim 1, wherein the member is an edge folding device.

8. A gypsum slurry supply stabilizing device in which ultrasonic vibration is provided to a member coming into contact with a gypsum slurry containing air bubbles.

9. The gypsum slurry supply stabilizing device according to claim 8, wherein the ultrasonic vibration is an ultrasonic wave having a frequency of 10 to 100 kHz.

10. The gypsum slurry supply stabilizing device according to claim 8, wherein the material of the member is metal.

11. The gypsum slurry supply stabilizing device according to claim 8, wherein the member is a gypsum slurry supply device.

12. The gypsum slurry supply stabilizing device according to claim 8, wherein the member is a gypsum slurry flow control device.

13. The gypsum slurry supply stabilizing device according to claim 8, wherein the member is a gypsum foreign matter stop device.

14. The gypsum slurry supply stabilizing device according to claim 8, wherein the member is an edge folding device.

15. A method of manufacturing a gypsum board characterized by using the gypsum slurry stabilizing device according to claim 8.
